(19) United States
(12) Patent Application Publication
(10) Pub. No.: US 2006/0024140 A1
(43) Pub. Date: Feb. 2, 2006

(54) Removable tap chasers and tap systems including the same

(76) Inventors: Edward C. Wolff, Waynesboro, PA (US); Donald G. Barnes, State Line, PA (US); V. Brian Shook, Waynesboro, PA (US)

Correspondence Address: ALLEGHENY TECHNOLOGIES, 1000 SIX PPG PLACE, PITTSBURGH, PA, 15222, US

(21) Appl. No.: 10/903,198

(22) Filed: Jul. 30, 2004

(51) Int. Cl. B23B 35/00

(52) U.S. Cl. 408/1 R

(57) ABSTRACT

The present disclosure provides a removable tap chaser for tapping an internal thread in a hole in a workpiece. The tap chaser consists of at least one carbide material and is adapted to be removably mounted on a tap system such as, for example, one of a collapsible tap system and a non-collapsible tap system.

### BACKGROUND OF THE TECHNOLOGY

1. Field of Technology

The present disclosure is directed to removable and replaceable tap chasers adapted for use with tap systems. One aspect of the present disclosure is more particularly directed to removable and replaceable tap chasers adapted for use in collapsible and non-collapsible tap systems designed for cutting internal threads in a single pass into the workpiece. The novel tap chasers described in the present disclosure may significantly improve machining productivity, reduce the cost of machined parts, increase tool life, and improve thread quality and finish.

2. Description of the Background of the Technology

“Tapping” is generally defined as a machining process for producing internal threads. As is known in the machining arts, a “tap” is a thread-cutting tool having cutting elements of a desired form on the periphery. Combining rotary motion with axial motion, the tap cuts or forms threads on the internal walls of a hole (referred to as “internal threads”) in a workpiece. See, for example, ASM Handbook, Volume 16 “Machining” (ASM Intern. 1989), p. 255. During tapping, the internal thread may be formed in a single pass. As such, compared with other methods of forming internal threads such as, for example, thread turning and thread milling, tapping is highly efficient and produces a relatively high volume of machined parts. Machines most commonly used to drive a tap are drill presses, dedicated tapping machines, gang machines, manual or automatic turret lathes, and certain other multiple-operation machines. Tapping machines essentially are drill presses equipped with lead screws, tap holders, and reversing drives.

Taps are available in several different forms including, for example, a single-piece solid tap, a composite solid tap, a tap assembly that includes a collapsible tap unit and a plurality of removable tap chasers (referred to herein as a “collapsible tap system”), and a tap assembly that includes a non-collapsible tap unit and a plurality of removable tap chasers (referred to herein as a “non-collapsible tap system”). Both collapsible taps and non-collapsible taps typically are “inserted-chaser taps”, which include a chaser body having slots that accept sets of tap chasers. The tap chasers are held in place on the chaser body by, for example, wedges, screws, or grooves, or by a combination of screws and serrations cut into the chaser body. Collapsible taps include chasers that may retract radially after the thread has been cut, so that the tap can be withdrawn from the workpiece without need for reverse rotation. Certain non-collapsible taps can be configured in a number of ways, to tap holes within a range of diameters, but such taps lack an ability to retract radially.

Single-piece solid taps have been widely used in various applications for many years. Certain embodiments of conventional single-piece solid taps are fabricated from high speed steels, alloy steels, or tool steels, while other embodiments are formed from hard carbide materials. A drawback of a single-piece solid tap is that once the tap cutting edge has reached a wear limit or has been chipped or otherwise damaged during thread tapping, the entire solid tap must be discarded. This makes the use of single-piece solid taps largely economically unfavorable, particularly in the case of costly single-piece solid taps formed from carbide materials. Also, solid tap thread form parameters, including pitch diameter, are not adjustable, and thus a different tap is needed to form threads of differing parameters. A representative single-piece solid tap fabricated from titanium-base metal alloy is described in European Patent No. 0 641 620.

An improvement over the single-piece solid tap is a tap composed of a steel tap body to which is brazed either multiple carbide material tap inserts or a single carbide material tap head. This tap design uses significantly less carbide material than single-piece solid taps composed entirely of carbide material. This tap design, however, suffers from the same drawback as a single-piece solid tap formed from one material in that the entire tap may need to be discarded if the cutting teeth are worn or damaged. A representative tap including a steel tap body having a carbide tap head brazed thereto is described in, for example, United Kingdom Patent No. 2,324,752.

One other improved tap design includes a relatively soft steel tap body and a hard carbide material tap head that is releasably mechanically fastened to the tap body. In this design, the carbide tap head may be replaced once worn or damaged. A representative tap of this design is provided in WIPO International Publication No. 03/011508, which describes a tap including a single-piece carbide tap head that is releasably fastened to a steel tap body by a fixation device, such as a screw. Although the carbide tap head is replaceable, however, the tap diameter is not adjustable, and the entire replaceable tap head must be discarded once a wear limit is reached or chipping or other unacceptable damage occurs to the tap head.

Yet another development in this area is a composite solid tap, which is a design that also reduces the need for use of carbide materials. U.S. Pat. No. 5,487,626 provides one example of a composite solid tap design comprising a core of high speed steel or tool steel and a sheath of relatively hard material such as carbides, nitrides, and/or carbonitrides. Given that the tap is a solid component, however, the entire tap must be discarded when unacceptable wear or damage occurs.

A collapsible tap system may include a tap body and a set of detachable tap heads equipped with a plurality of removable tap chasers. Such a system is quite versatile in that the tap may be used to perform a wide range of internal thread work. Because a collapsible tap system includes several removable tap chasers, single tap chasers may be replaced or may be removed, ground and re-installed as needed. In addition, simple adjustment to tap chaser position to compensate for pitch diameter errors introduced by tap chaser wear may extend the service life of tap chasers in a collapsible tap system. Patents describing collapsible tap system designs include, for example, U.S. Pat. Nos. 3,041,641 and 4,097,180. Both of these patents are directed to designs wherein the tap chasers are fabricated from non-carbide materials such as high speed steels or tool steels.

A non-collapsible tap system also may include detachable tap heads. In addition, positions of the system's removable tap chasers may be adjusted, such as by fastening screws or the combined action of a central screw and a plunger, so as to tap different hole sizes. This allows one tap unit to be used for internal thread work having a wide range of pitch diameters. As with a collapsible tap system, a non-collapsible tap system may be equipped with a plurality of removable tap chasers, so that only individual tap chasers need be replaced or removed and restored to a useful condition, as necessary. Also as with a collapsible tap system, the service life of a non-collapsible tap system's tap chasers may be extended by appropriate position adjustment to compensate for pitch diameter errors introduced through wear.

Although the removable and replaceable nature of tap chasers in collapsible and non-collapsible tap systems provides a distinct advantage relative to solid taps, removing even a single tap chaser from such systems requires taking the entire tap system out of service for a period of time. Given that a collapsible or non-collapsible tap system includes multiple tap chasers that may be removed or replaced individually as they wear or are damaged, service downtime for chaser replacement can be significant. As such, an improvement in the service life of individual tap chasers used in, for example, collapsible and non-collapsible tap systems, may provide a significant increase in the continuity of the service life of the tap systems, and thereby improve throughput on the machine tool. Improved throughput, in turn, may reduce part cost.

### SUMMARY

The present disclosure is directed to improvements in removable tap chasers. In particular, one aspect of the present disclosure is directed to removable tap chasers adapted for tapping internal threads in holes in workpieces, wherein the tap chasers are fabricated from carbide material. As used herein, a “carbide material”, as defined herein.

Carbide material has improved resistance to wear relative to high speed steels, tool steels, and other materials from which removable/replaceble tap chasers are conventionally formed. In certain embodiments, tap chasers of the present disclosure are adapted to be removably mounted on a chaser body of one of collapsible tap system and a non-collapsible tap system and may be removed and either replaced or restored to useful condition (by, for example, grinding) and re-installed when unacceptably worn or damaged. The tap chasers of the present disclosure may be fabricated from any carbide material and have any geometry suitable for tapping threads in workpieces formed from particular materials of interest. Examples of possible geometries include standard-type and overhang-type chaser geometries. As is known in the art, standard-type tap chasers are typically used in thread tapping a hole that passes entirely through a workpiece, while overhang-type tap chasers are used in thread tapping a blind hole in a workpiece.

The carbide material tap chasers provided in the present disclosure may be manufactured from hard carbide materials using conventional techniques for forming carbide material cutting inserts used in other applications, such as thread turning and thread milling. The tap chasers described herein also optionally are provided with one or more coatings improving wear resistance and/or other properties, and which may be applied by, for example, chemical vapor deposition (CVD) or physical vapor deposition (PVD).

The removable carbide material tap chasers described in the present disclosure may be produced in either “left-hand” or “right-hand” shapes to provide cutting capabilities for both left-hand and right-hand thread specifications. Furthermore, the carbide material tap chasers described herein may be designed for use with taps, such as with collapsible or non-collapsibel tap systems, for either a revolving application, wherein the workpiece is stationary and the tap rotates and moves linearly, or a non-revolving application, wherein the workpiece rotates and the tap moves linearly without rotation to advance into the workpiece.

Incorporating the novel removable carbide material tap chasers of the present disclosure in a tap system such as, for example, a collapsible tap system or a non-collapsible tap system, provides a unique means to achieve highly efficient, high volume tapping and economically provide a wide range of quality internal threads. The unique combination of removable carbide material tap chasers in a collapsible or non-collapsible tap system as described herein improves tapping productivity, can improve thread quality, and increases length and continuity of tool service life, while maintaining the advantages of flexibility and range of applications available from these tap systems.

The reader will appreciate the foregoing details, as well as others, upon considering the following detailed description of certain non-limiting embodiments. The reader also may comprehend additional details of the present disclosure upon making and/or using the removable carbide material tap chasers and tap systems of the present disclosure.

### BRIEF DESCRIPTION OF THE FIGURES

FIG. 1 illustrates certain functional parameters of a removable tap chaser.

FIGS. 2(a)-(c) are several views of an embodiment of a carbide material tap chaser constructed according to the present disclosure.

FIG. 3(a)-(h) illustrate several possible non-limiting profiles of a chip groove of a carbide material tap chaser constructed according to the present disclosure.

FIGS. 4(a) and (b) are fragmentary views of two asymmetric tooth profiles of embodiments of carbide material tap chasers constructed according to the present disclosure.

FIGS. 5(a)-(c) are several views of an embodiment of an overhang-type carbide material tap chaser constructed according to the present disclosure.

FIG. 6 is a fragmentary view illustrating certain aspects of an embodiment of a chamfered carbide material tap chaser constructed according to the present disclosure.

FIG. 7 is a schematic diagram of an embodiment of a collapsible tap system including removable carbide material tap chasers constructed according to the present disclosure.

FIG. 8 illustrates three embodiments of collapsible tap systems including removable carbide material tap chasers constructed according to the present disclosure.

FIGS. 9(a) and (b) illustrate certain embodiments of tap systems equipped with removable standard-type tap chasers and overhang-type tap chasers, respectively, fabricated from carbide material according to the present disclosure.

FIG. 10(a) is an exploded assembly view of an embodiment of a collapsible tap system including removable carbide material tap chasers according to the present disclosure. FIG. 10(b) is an exploded assembly view of an embodiment of a non-collapsible tap system including removable carbide material tap chasers according to the present disclosure.

FIGS. 11(a) and (b) graphically compare machining performance of tap systems incorporating carbide material tap chasers and high speed steel tap chasers under different cutting conditions.

### DETAILED DESCRIPTION OF CERTAIN EMBODIMENTS

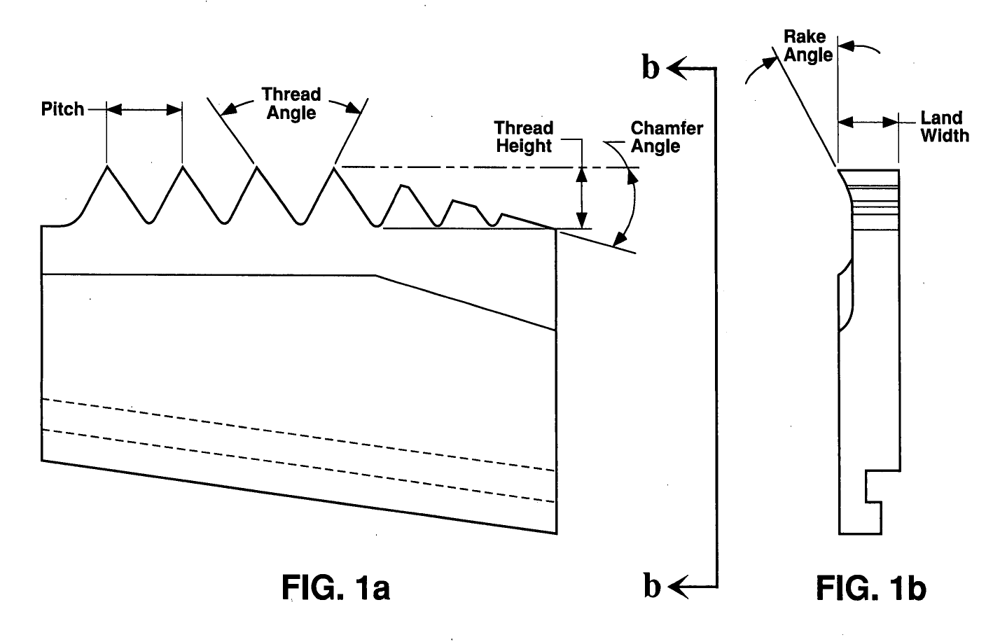

Views of one non-limiting embodiment of a standard-type tap chaser fabricated from carbide material according to the present disclosure is shown in FIGS. 1(a) and (b). FIG. 1(b) is an elevational view taken of the tap chaser of FIG. 1(a) taken in the direction of arrows b-b in FIG. 1(a). As indicated in FIGS. 1(a) and (b), aspects of the tap chaser embodiment shown therein may be described by the following functional parameters:
Pitch—The distance from any point on a cutting tooth (which also is referred to herein as a “tap thread”) to a corresponding point on and adjacent tap thread. Pitch is a basic parameter of the tapped thread form.
Thread angle—The included angle between flanks of adjacent tap threads. Thread angle also is a basic parameter of the tapped thread form.
Thread height—The distance between the crest and the base of a tap thread. Thread height is an additional basic parameter of the tapped thread form.
Chamfer angle—The taper angle of the tap threads at the end of a tap chaser. The taper angle provides clearance for the cutting action as the tap advances into an untapped hole.
Land width—The distance from the crest at the cutting edge to the bottom face of a tap chaser.
Rake angle—A characteristic of the chip groove, defined as a deviation from a straight cutting face of the thread tooth to a grooved cutting face of the thread tooth. The rake angle affects chip flow, chip formation, and cutting forces.

Removable carbide material tap chasers constructed according to the present disclosure may be produced in any suitable geometric shape. Two common tap chaser configurations are standard-type tap chasers (also referred to as “regular” tap chasers) and overhang-type tap chasers (also referred to as “projection” tap chasers or “extended projection” tap chasers).

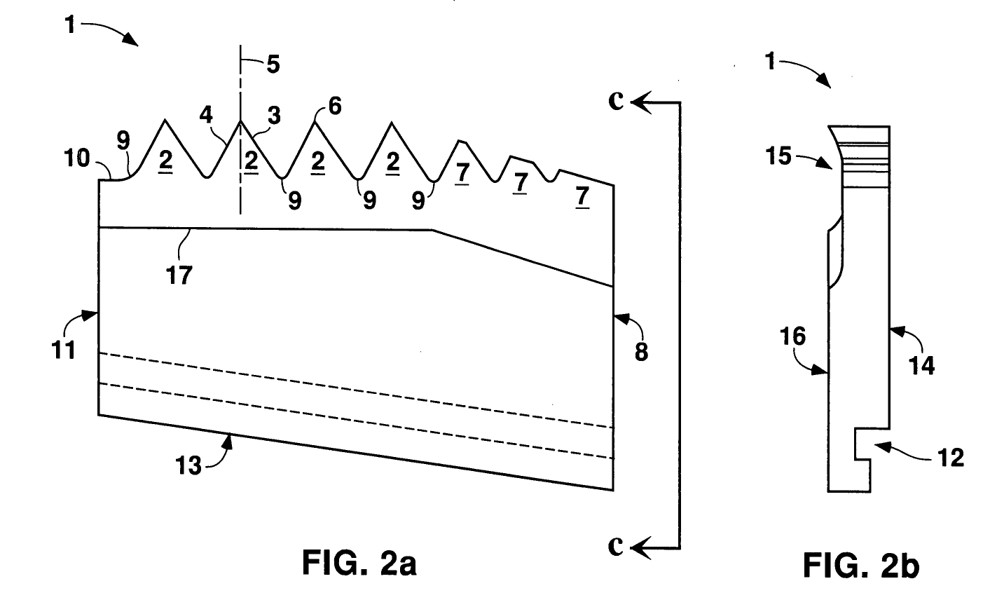

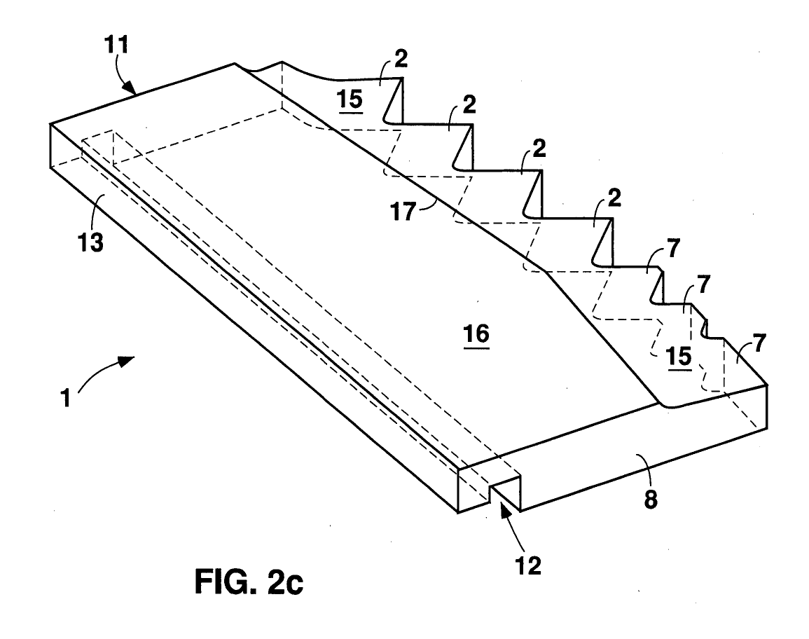

An embodiment of a standard-type tap chaser fabricated from carbide material according to the present disclosure is referenced as 1 in FIGS. 2(a)-(c). Carbide material tap chaser 1 includes four substantially identical thread teeth 2 spaced at a distance equal to the thread pitch, as defined in FIG. 1. Other non-limiting embodiments of carbide material tap chaser 1 may include, for example, three to sixty-four substantially identical thread teeth. As shown in FIG. 2(a), each thread tooth 2 comprises a front flank 3 and a back flank 4, which are either symmetric or asymmetric to the tooth axis 5. An asymmetric thread tooth may be configured so that, for example, the front flank 3 does not have the same profile as the back flank 4, and/or the angle formed between the front flank 3 and the tooth axis 5 may be unequal to the angle formed between the back flank 4 and the tooth axis 5. The tooth crest 6 may be, for example, a sharp point, a round arc with a radius, or a flat face.

Carbide material tap chaser 1 also includes three teeth 7 that are truncated or include a chamfer angle, as defined in FIG. 1, to provide a chamfered clearance near the front end wall 8 of the tap chaser 1. Other embodiments of the carbide material tap chaser 1 may include, for example, zero to ten truncated or chamfered thread teeth. A connecting root 9 exists between identical teeth 2, between identical tooth 2 and chamfered tooth 7, between tooth 2 and end face 10 proximate back end wall 11, and between chamfered teeth 7. End wall 11 is spaced apart from and substantially parallel to front end wall 8.

Again referring to FIGS. 2(a)-(c), carbide material tap chaser 1 includes slot 12 to mount and position tap chaser 1 in, for example, a collapsible or non-collapsible tap system. Slot 12 is formed adjacent lower end face 13, on bottom face 14, and runs from front end wall 8 to back end wall 11. In order to improve cutting performance, carbide material tap chaser 1 may include chip groove 15 on top face 16. Chip groove 15 may extend from front end wall 8 to back end wall 11, and from tooth crest 6 and end at line 17 on top face 16. The rake angle of chip groove 15 may be in the range of, for example, −7° to 65°. Furthermore, the rake angle of chip groove 15 for chamfered teeth 7 may differ from that of the substantially identical teeth 2, either as a difference in design or as a result of a compound angle effect due to the chamfered angle formed on chamfered teeth 7.

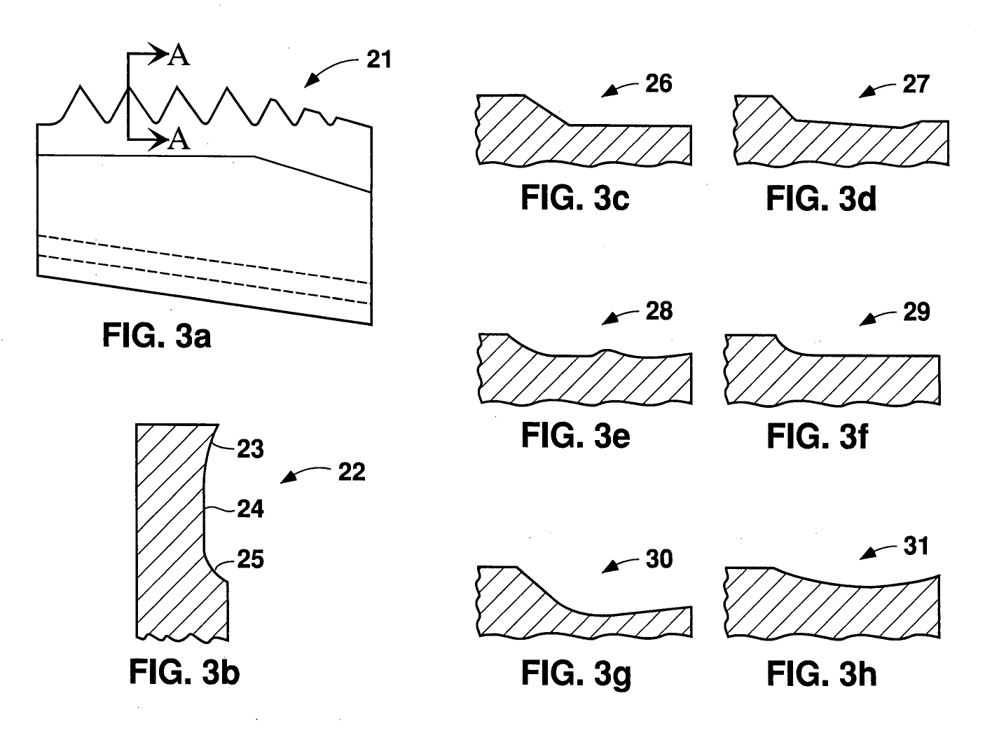

FIG. 2(b) is an elevational view taken on end in the direction of c-c in FIG. 2(a). The profile of chip groove 15, shown in FIG. 2(b), may be any suitable geometry. In general, the chip groove profile may be one or a combination of lines, arcs, and spline curves. FIGS. 3(a)-(h) illustrate various possible alternate chip groove profiles. The sectional view of FIG. 3(b) is derived by viewing the tap chaser 21 of FIG. 3(a) at segment A-A in the direction of the arrows. The profile of chip groove 22 of tap chaser 21 shown in FIG. 3(b) includes arc portions 23 and 25, and linear portion 24. Embodiments of alternate chip groove profiles are shown as profiles 26-31 in FIGS. 3(c)-(h), respectively. The selection of an appropriate chip groove profile for a certain tapping application may be readily accomplished by one of ordinary skill in the art, and it will be understood that the profiles shown in FIG. 3 are not exhaustive of the possible chip groove profiles and are offered by way of example only.

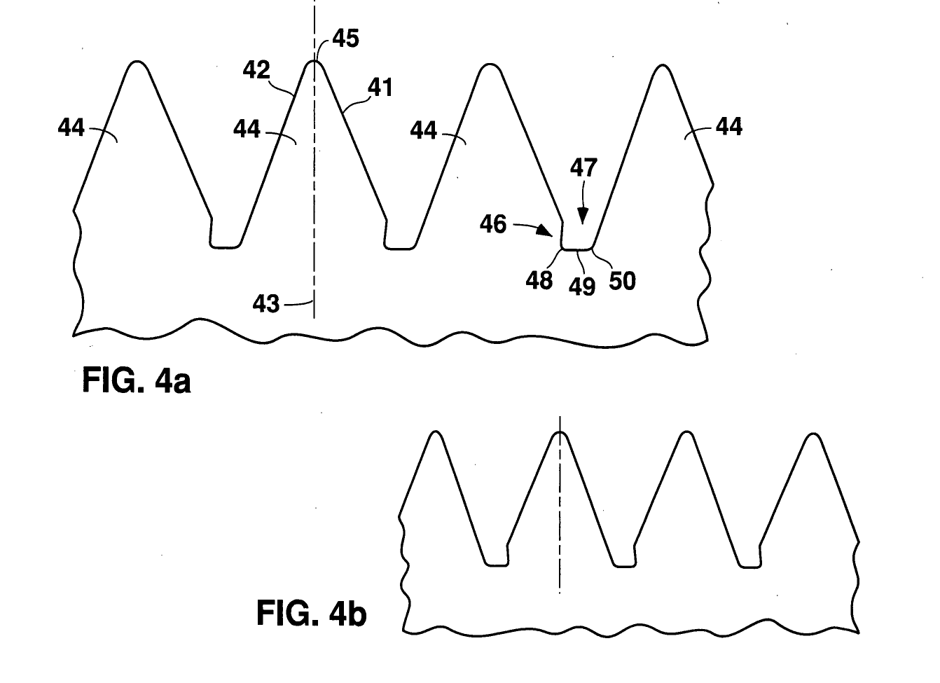

As noted, each of substantially identical thread teeth 2 shown in FIGS. 2(a) and (c) is either symmetric or asymmetric to the respective tooth axis 5. Furthermore, each identical thread tooth 2 may have a relieved profile near the tooth root 9 at the opposite flank of each identical tooth. Such a tooth profile may be of the general form shown in, for example, U.S. Pat. No. 4,752,164. FIGS. 4(a) and (b) are fragmentary views illustrating two possible non-limiting profiles of substantially identical thread teeth 44 having geometric features that are asymmetric with respect to the tooth profile. With respect to FIG. 4(a), each thread tooth 44 comprises a front flank 41, a tooth crest 45, a back flank 42, and a relieved profile 46 at the lower portion of the front flank 41. The profiles of front flank 41 and back flank 42 are asymmetric with respect to tooth axis 43. The identical thread teeth 44 of FIG. 4(a) are connected to each other through a thread root 47 that may include, for example, arc portion 48, linear portion 49, and arc portion 50. Relieved profile 46 may be, for example, parallel to tooth axis 43 or tilted so as to form a small angle relative to tooth axis 43. FIG. 4(b) illustrates a possible alternate thread tooth profile, wherein the profile is a virtual mirror image of the profile shown in FIG. 4(a).

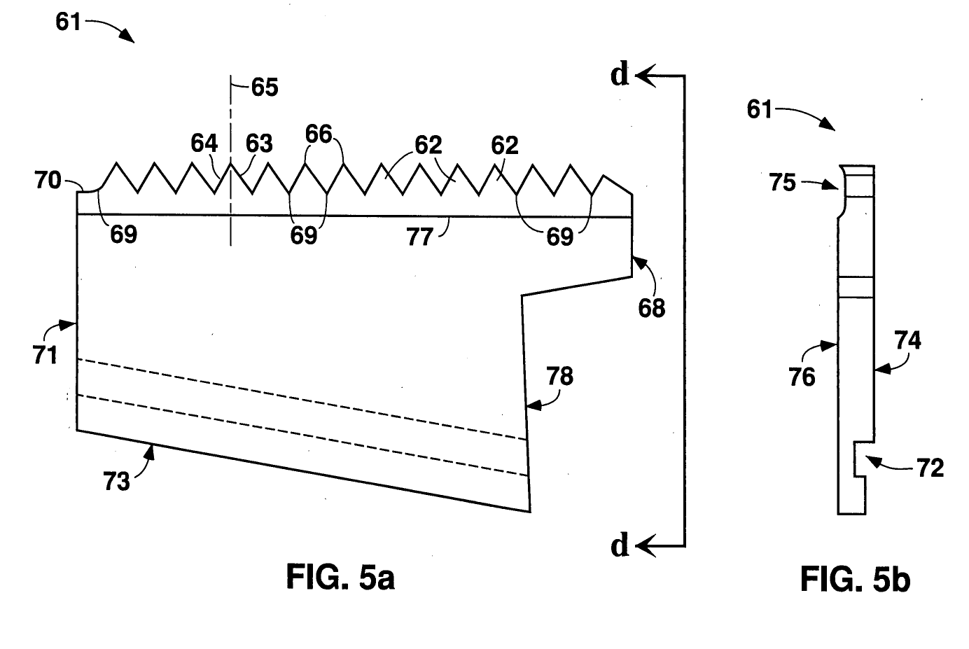

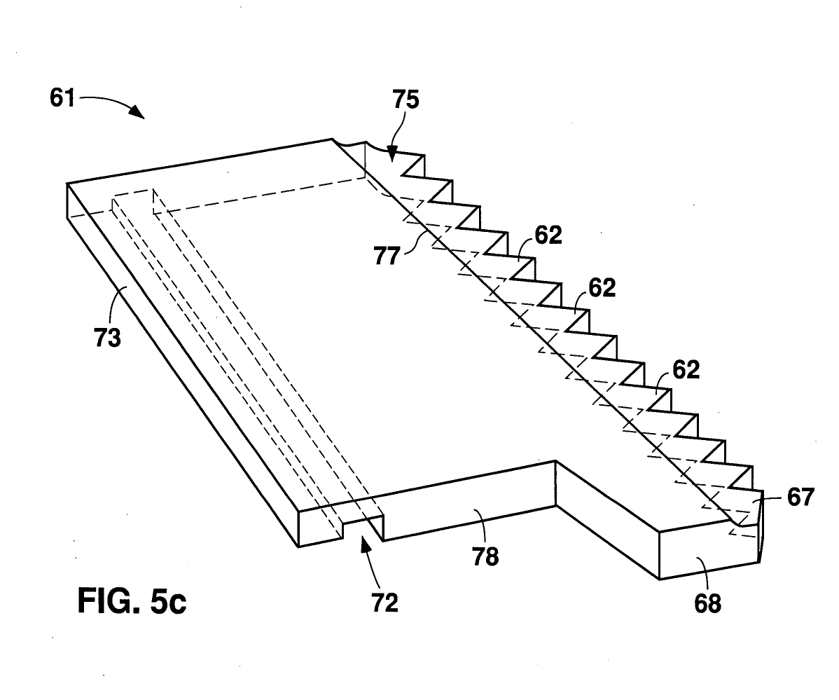

FIGS. 5(a)-(c) illustrate several views of one non-limiting embodiment of an overhang-type carbide material tap chaser 61 constructed according to the present disclosure. FIG. 5(b) is an elevational view taken on end in the direction of arrows d-d in FIG. 5(a). Tap chaser 61 includes a number of substantially identical thread teeth 62 spaced apart a distance equal to the thread pitch, as defined in connection with FIG. 1. Although tap chaser 61 is shown with thirteen substantially identical thread teeth 62, as noted above, other embodiments may include, for example, from three to sixty-four substantially identical thread teeth. Each thread tooth 62 comprises front flank 63 and rear flank 64 (which are either symmetric or asymmetric to tooth axis 65) and crest 66 (which may be, for example, a sharp point, a round arc with a radius, or a flat face). Carbide material tap chaser 61 also may include one or more teeth 67 that are tapered or truncated with a chamfer angle (as defined in FIG. 1) so as to provide a chamfered clearance near the upper front end wall 68 of tap chaser 61. Connecting roots 69, which may each be in the form of, for example, an arc, a point, or a small flat face, are formed between identical teeth 62, between a single tooth 62 and chamfered tooth 67, and between a single tooth 62 and end face 70 proximate the back end wall 71. Back end wall 71 is spaced parallel to front end wall 68.

Carbide material tap chaser 61 includes slot 72 to mount and position the tap chaser in a tap system, such as a collapsible or non-collapsible tap system, adapted to receive removable tap chasers. Slot 72 is near lower end face 73 and is located on bottom face 74. Slot 72 may run from lower front end wall 78 to back end wall 71. Carbide material tap chaser 61 may include chip groove 75, formed on top face 76, so as to improve cutting performance. Chip groove 75 may run from front end wall 68 to back end wall 71, and may extend from tooth crest 66 to line 77. The profile of chip groove 75 may have any suitable geometric configuration. For example, as illustrated in FIGS. 3(a)-(h), the chip groove profile may be formed of one or a combination of lines, arcs, and spline curves. Carbide material tap chaser 61 may also include thread teeth having any suitable tooth profile, non-limiting examples of which are shown in FIGS. 4(a) and (b).

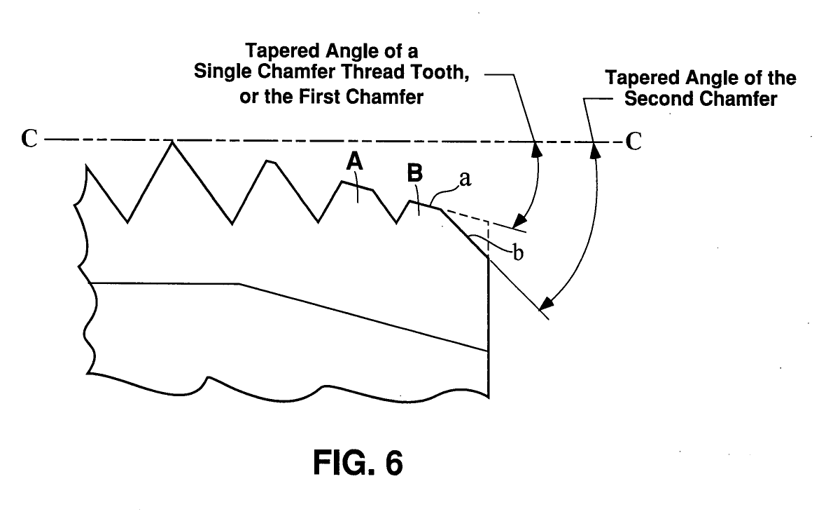

For both standard-type and overhang-type carbide material tap chasers, as shown in the fragmentary view of FIG. 6, each thread tooth including a chamfer angle may be of, for example, a single chamfer form (such as “A” in FIG. 6) or a double chamfer form (such as “B” in FIG. 6). The chamfer angle of single chamfer thread tooth A and of the first chamfer “a” of double chamfer thread tooth B in FIG. 6 (measured relative to line segment C-C) may range from, for example, 0° to 60°. The chamfer angle of the second chamfer “b” of double chamfer thread tooth B is larger than the angle of the first chamfer “a” and may range from, for example, 1° to 75°.

The various thread forms that may be produced by removable carbide material tap chasers according to the present disclosure that have been mounted to tap systems such as, for example, collapsible or non-collapsible tap systems, include but are not limited to the following standard thread forms: American Petroleum Institute (API); National Taper Pipe Thread (NPT); American Standard Straight Pipe for Mechanical Joints (NPSM); American Standard Straight Pipe for Couplings (NPSC); American Standard Straight Pipe (NPS); British Standard Parallel Pipe (BSPP); British Standard Tapered Pipe (BSTP); ACME; Stub ACME; Modified ACME; Unified (UN); and ISO (Metric).

As used herein, “carbide material” refers to a material having properties suitable for use as a tap chaser and that is substantially composed of (i.e., includes at least 60 weight percent of) tungsten carbide and/or any other single or combination of suitable hard metal carbides. It will be understood that in certain embodiments the carbide material may be a cemented carbide material, wherein the carbide material is provided as a hard discontinuous phase within a relatively soft continuous binder phase, such as cobalt, nickel, or a combination of cobalt and nickel. Such a composite material may include, for example, in the range of 1 to 40 weight percent binder phase. In other applications, the carbide material is not a composite. In any case, the carbide material preferably is substantially tungsten carbide, but may also be, for example, substantially composed of one or a combination of tungsten carbide and other metal carbides from which cutting inserts used in other thread forming applications are conventionally formed. Such other carbide materials include, for example, those comprising tungsten-titanium carbide and tungsten-titanium-tantalum (-niobium) carbides. The particular carbide material chosen will depend on the intended cutting conditions including, but not limited to, the material to be tapped, and those with ordinary skill in the art may readily select a suitable carbide material based on such conditions and other factors.

As noted above, carbide material tap chasers according to the present disclosure may be coated or uncoated. Tap chasers may be coated using conventional cutting insert coating techniques, such as CVD and PVD. Such coatings may comprise any desired conventional coating materials in suitable thicknesses and, optionally, combinations. For examples, such coating materials may be at least one of a metal carbide, a metal nitride, a metal silicide and a metal oxide of a metal selected from groups IIIA, IVB, VB, and VIB of the periodic table. Specific non-limiting examples of coatings that may be included on removable carbide material tap chasers according to the present disclosure include the following: titanium nitride (TiN); titanium carbonitride (TiCN); titanium aluminum nitride (TiAlN); titanium aluminum nitride plus carbon (TiAlN+C); aluminum titanium nitride (AlTiN); aluminum titanium nitride plus carbon (AlTiN+C); titanium aluminum nitride plus tungsten carbide/carbon (TiAlN+WC/C); aluminum titanium nitride plus tungsten carbide/carbon (AlTiN+WC/C); aluminum oxide (Al₂O₃); titanium diboride (TiB₂); tungsten carbide carbon (WC/C); chromium nitride (CrN); and aluminum chromium nitride (AlCrN). Such single or multiple coatings typically have a total thickness of about 1 to about 24 microns.

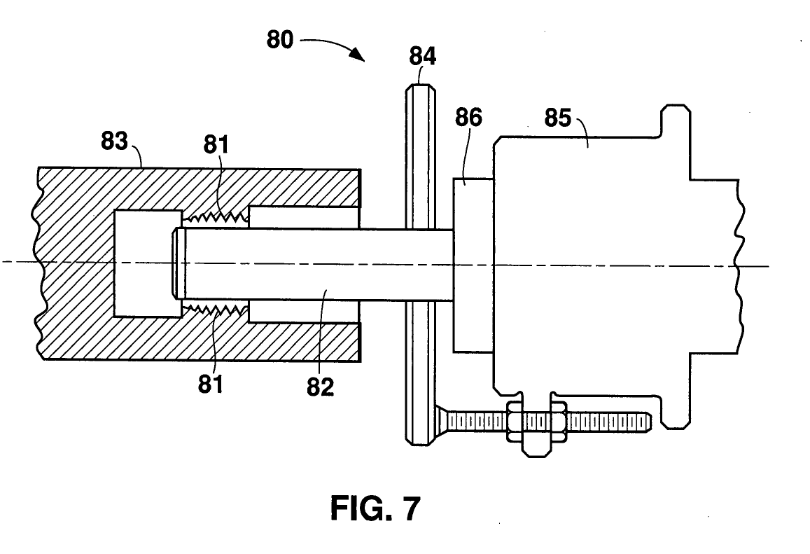

FIG. 7 is a schematic view of on embodiment of a collapsible tap system 80. A plurality of carbide material tap chasers 81 constructed according to the present disclosure are mounted on tap head 82 and are shown in FIG. 7 in the process of cutting an internal thread in an existing hole in workpiece 83 (shown sectioned to reveal tap head 82). Thread length may be regulated by suitably positioning trip ring 84. Tap head 82 may be detachable and interchangeable with additional tap heads to allow the system to form a wide range of internal thread sizes. Tap head 82 may be attached to tap body 85 at flange 86.

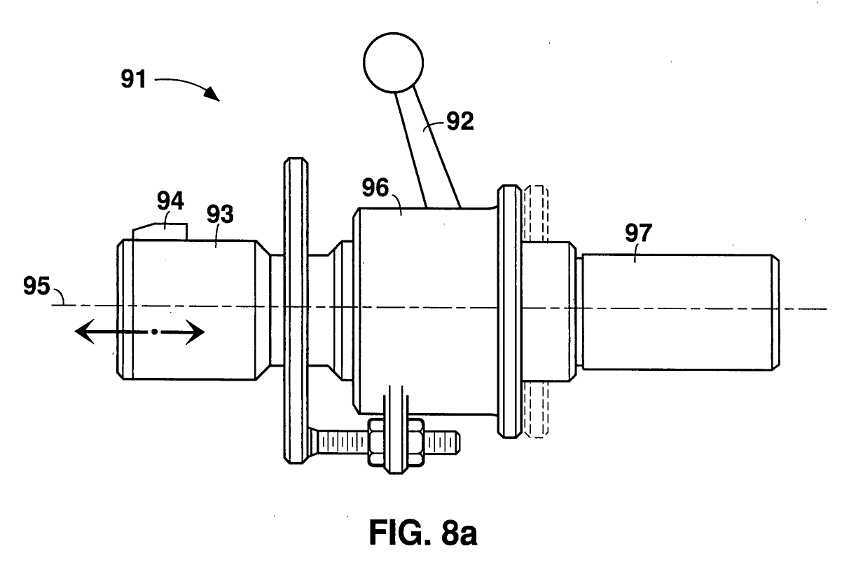

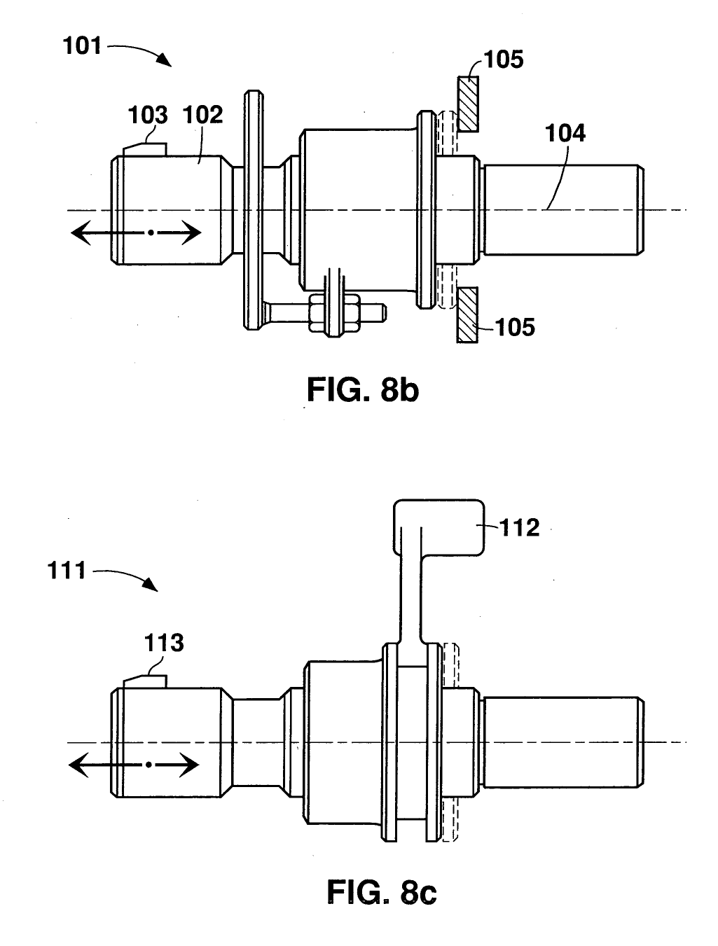

As shown in the schematic illustrations of FIGS. 8(a)-(c), carbide material tap chasers constructed according to the present disclosure may be incorporated in various collapsible tap system designs. FIG. 8(a) illustrates a stationary collapsible tap system 91 designed to tap an internal thread into a revolving workpiece. Tap head 93 is equipped with multiple removable carbide material tap chasers 94 constructed according to the present invention and does not rotate, but rather advances and retracts linearly along tap axis 95. Lever 92 is manipulated to linearly advance and retract tap head 93, and tap head 93 collapses when retracted. Tap head 93 is adjustably and detachably mounted to tap body 96 which, in turn, can slide along shaft shank 97.

FIG. 8(b) depicts a rotary collapsible tap system 101 used to tap an internal thread into a stationary workpiece. Tap head 102 is equipped with multiple removable carbide material tap chasers 103 according to the present disclosure and rotates about tap axis 104 during the tapping operation. Set-up shoes 105 accomplish the collapsible action of tap system 101.

FIG. 8(c) depicts a yoke-operated rotary collapsible tap system 111, which is used to tap an internal thread on a bar automatic machine or in other tapping applications where the workpiece location is constant. Tap system 111 includes multiple removable carbide material tap chasers 113 according to the present disclosure. The collapsible action of tap system 111 is achieved by means of operating yoke 112.

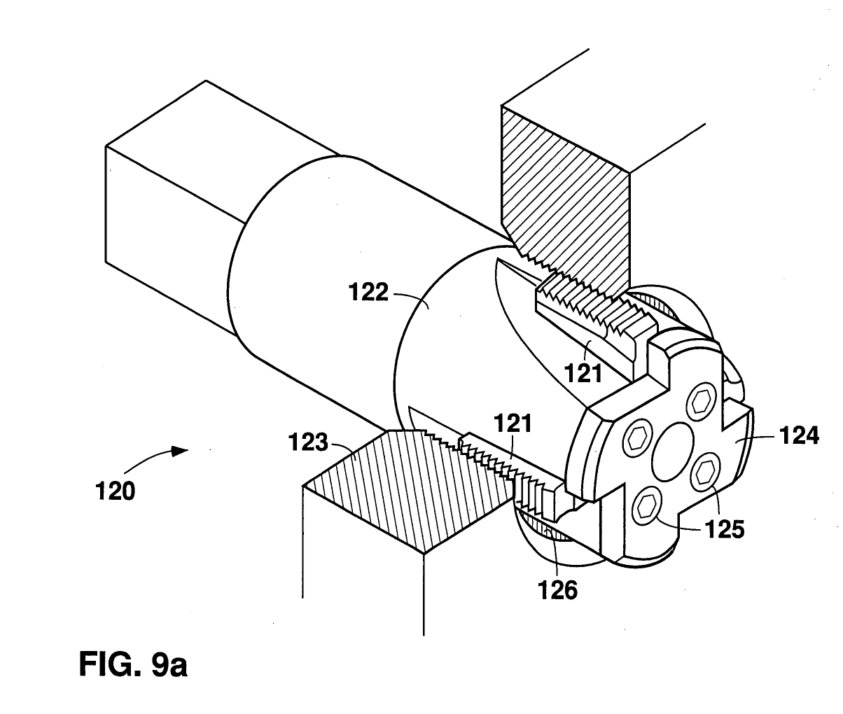

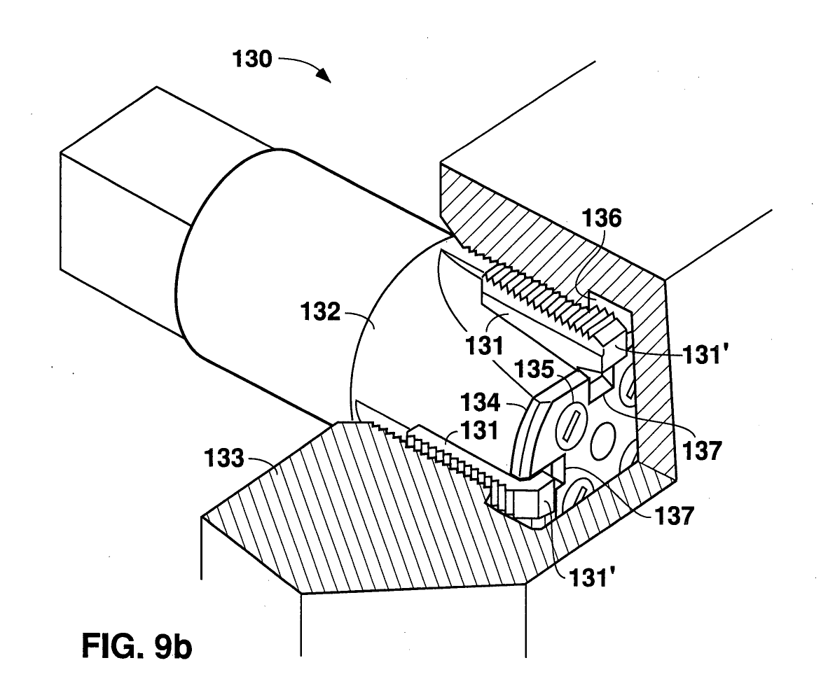

FIGS. 9(a) and (b) are schematic illustrations of two non-limiting embodiments of non-collapsible tap units constructed according to the present disclosure. In tap system 120 of FIG. 9(a), a plurality of standard type carbide material tap chasers 121 constructed according to the present disclosure are mounted on tap head 122 and are used to cut an internal thread into an existing through hole 126 in workpiece 123 (shown sectioned to reveal a portion of the tap head). Cap portion 124 and screws 125 retain carbide material tap chasers 121 on tap head 122. In tap system 130 of FIG. 9(b), a plurality of overhang-type carbide material tap chasers 131 constructed according to the present disclosure are mounted on tap head 132 and are used to cut an internal thread in blind hole 136 formed in workpiece 133 (shown sectioned to reveal tap head 132). Cap portion 134 and screws 135 retain carbide material tap chasers 131 on tap head 132. Cap portion 134 includes several slots 137 allowing the projecting portion 131′ of each tap chaser 131 to extend through the slots 131′ in order to completely tap blind hole 136.

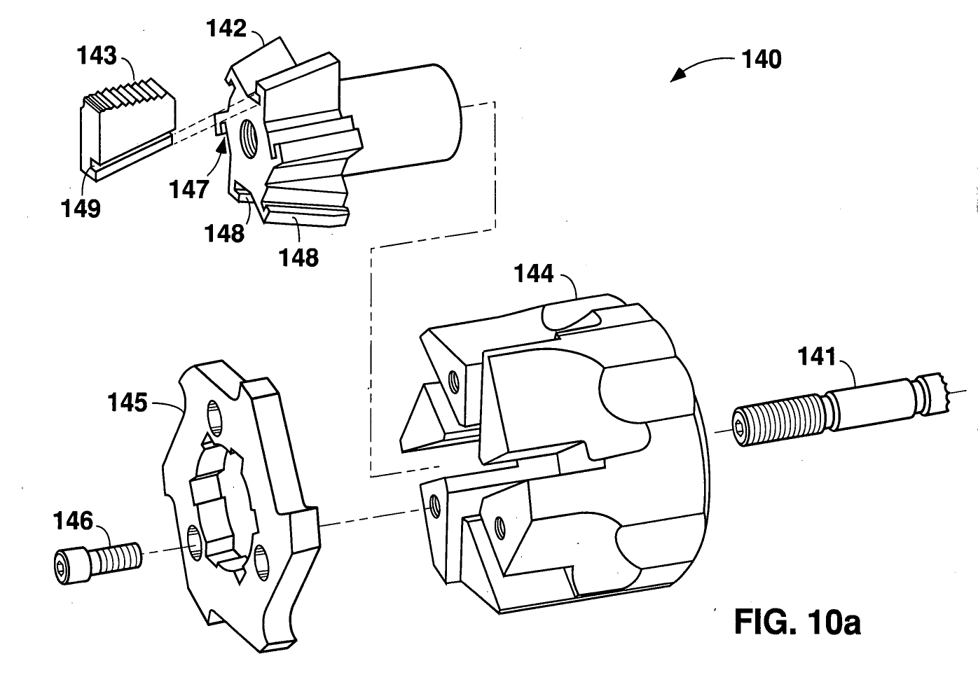

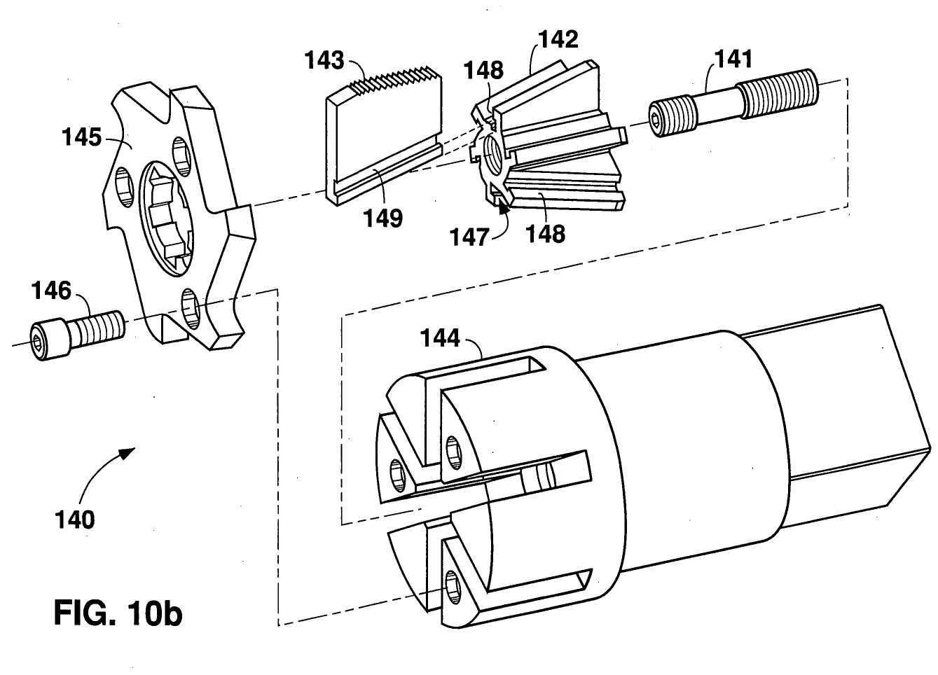

Certain embodiments of collapsible and non-collapsible tap system equipped with either standard-type or overhang-type carbide material tap chasers according to the present disclosure may be adjusted to provide varying pitch diameters. This capability is illustrated in FIGS. 10(a) and (b), which are exploded assembly views of a portion of tap head assembly 140 for both collapsible (FIG. 10(a)) and non-collapsible tap systems (FIG. 10(b)). Tap head assembly 140 includes a ratchet-type adjusting screw 141 having a self-locking function. Adjusting screw 141 is threaded into an end of plunger 142 so as to be positioned inside the nose of tap head 144. Plunger 142 includes multiple slots 147, each of which receives a carbide material tap chaser 143 according to the present disclosure. Flange 148 of each slot 147 is slidingly received within slot 149 of a tap chaser 143. The adjusting screw 141 is configured so that a given amount of rotation of screw 141 produces movement of the carbide material tap chasers 143 and a consequent known change in the diameter of the bore that may be tapped by the tap system 140. When the amount of required diameter adjustment is known, it may be precisely obtained by a predetermined degree of rotation of adjusting screw 141. In this way, too, adjustment of the tap diameter of an collapsible or non-collapsible tap system can be quickly and easily made to compensate for carbide material tap chaser wear or reduction in dimensions caused by regrinding of worn tap chasers. Retaining cap 145 and fastening screws 146 retain carbide material tap chasers 143 on plunger 142.

The removable carbide material tap chasers according to the present disclosure provide certain advantages of conventional single-piece solid carbide taps in that the carbide material is substantially more wear resistant than high speed steel or other materials from which removable tap chasers are conventionally formed. Incorporating the present removable carbide material tap chasers in a collapsible or non-collapsible tap system significantly reduces machining costs and enables a single set of carbide material tap chasers to be used in a wide range of thread tapping applications. In addition, it is expected that incorporating the present removable carbide material tap chasers in tap systems such as, for example, collapsible or non-collapsible tap system according to the present disclosure would significantly increase machining productivity, reduce threaded parts manufacturing cost, improve thread quality and finish, and allow for a high level of flexibility of application.

The following comparative machining test examples were conducted at differing cutting conditions in order to evaluate advantages of carbide material tap chasers and tap systems according to the present disclosure.

### EXAMPLE 1

A conventional overhang-type high speed steel tap chaser and an overhang-type uncoated carbide material tap chaser constructed according to the present disclosure were used to tap internal threads in holes formed in cast red brass (85-5-5-5) workpieces using one of a non-collapsible tap system. The tap chasers had substantially identical thread form and geometry. The cutting conditions were as follows:
Surface speed—200 feet per minute (61 meters per minute)
Rotational speed—612 revolutions per minute
Diameter of hole to be tapped—1.266 inches (32.16 mm)
Pitch to be formed—14 teeth per inch (0.071 inch)
Thread form to be tapped—National Taper Pipe Thread (NPT)
Coolant—no coolant used

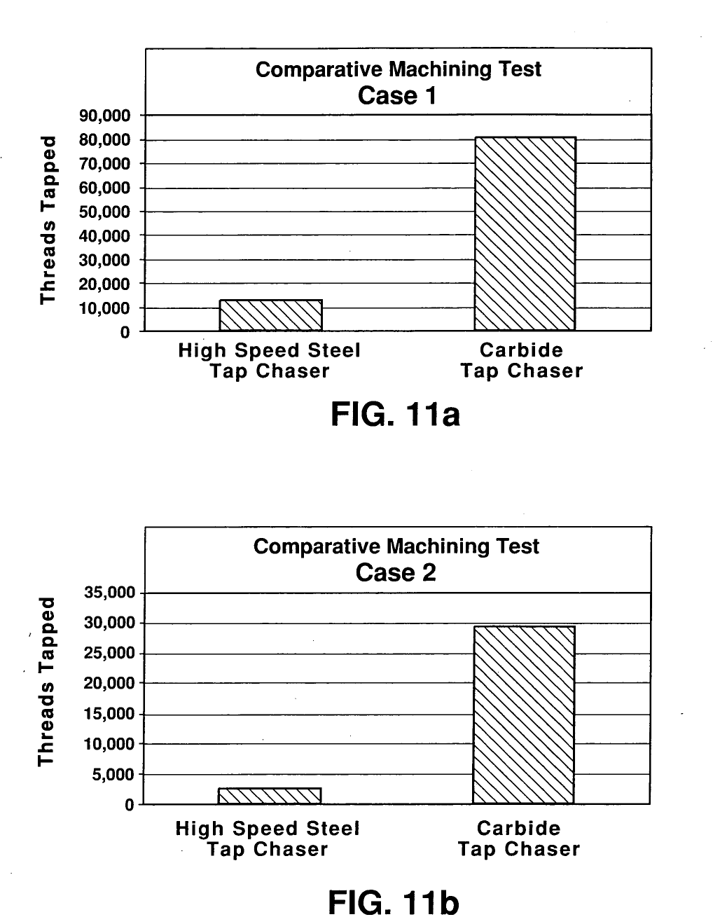

The test results are graphically presented in FIG. 11(a). The high speed steel tap chaser successfully tapped threads in approximately 13,000 internal holes before the tap chaser became unacceptably worn. In contrast, the carbide material tap chaser tapped threads in approximately 80,000 internal holes before becoming unacceptably worn. Thus, the removable and replaceable carbide material tap chasers evaluated in this example outperformed high speed steel tap chasers by over 6 times in terms of the number of internal holes tapped.

### EXAMPLE 2

In a second comparative test, a conventional overhang-type high speed steel tap chaser and an overhang-type uncoated carbide material tap chaser constructed according to the present disclosure, having substantially identical thread form and geometry, were used to tap internal threads in holes formed in cast red brass (85-5-5-5) workpieces using the following cutting conditions:
Surface speed—300 feet per minute (91 meters per minute)
Rotational speed—500 revolutions per minute
Diameter to be tapped—2 inches (51 mm)
Pitch to be formed—11.5 teeth per inch (0.087 inch)
Thread form to be tapped—National Taper Pipe Thread (NPT)
Coolant—no coolant used

The test results are graphically presented in FIG. 11(b). Using the above machining conditions, the high speed steel tap chaser tapped threads in approximately 2500 internal holes before becoming unacceptably worn. In contrast, the carbide material tap chaser tapped threads in approximately 29,000 internal holes before experiencing unacceptable wear. Thus, the removable and replaceable carbide material tap chaser evaluated in this example outperformed the high speed steel tap chaser by over 11.5 times in terms of the number of internal holes tapped.

It is to be understood that the present description illustrates those aspects relevant to a clear understanding of the disclosure. Certain aspects that would be apparent to those skilled in the art and that, therefore, would not facilitate a better understanding have not been presented in order to simplify the present disclosure. Although the present disclosure has been described in connection with certain embodiments, those of ordinary skill in the art will, upon considering the foregoing disclosure, recognize that many modifications and variations may be employed. It is intended that the foregoing description and the following claims cover all such variations and modifications.

I claim:

1. A removable tap chaser for tapping an internal thread in a hole in a workpiece, wherein the tap chaser consists of at least one carbide material.

2. The tap chaser of claim 1, wherein the tap chaser is adapted to be removably mounted on one of collapsible tap system and a non-collapsible tap system.

3. The tap chaser of claim 1, wherein said carbide material is a tungsten-based carbide.

4. The tap chaser of claim 1, wherein the tap chaser includes from 3 to 64 substantially identical thread teeth and from 0 to 10 thread teeth that are at least one of tapered and truncated to include at least one chamfer angle.

5. The tap chaser of claim 4, wherein each said substantially identical thread tooth comprises a front flank and a back flank that are one of symmetric and asymmetric to an axis of the thread tooth.

6. The tap chaser of claim 4, wherein at least one of said thread teeth having a chamfer angle is a single chamfer thread tooth having a chamfer angle of from 0° to 60°.

7. The tap chaser of claim 4, wherein at least one of said thread teeth having a chamfer angle is a double chamfer thread tooth having a first chamfer angle of from 0° to 60° and a second chamfer angle of from 1° to 75°.

8. The tap chaser of claim 1, wherein the tap chaser is one of a standard-type tap chaser and an overhang-type tap chaser.

9. The tap chaser of claim 1, wherein the tap chaser is adapted to be removably mounted on a tap head of one of a collapsible tap system and a non-collapsible tap system to produce internal thread forms meeting at least one standard selected from the group consisting of American Petroleum Institute (API), National Taper Pipe Thread (NPT), American Standard Straight Pipe for Mechanical Joints (NPSM), American Standard Straight Pipe for Couplings (NPSC), American Standard Straight Pipe (NPS), British Standard Parallel Pipe (BSPP), British Standard Tapered Pipe (BSTP), ACME, Stub ACME, Modified ACME, Unified (UN), and ISO (Metric) standards.

10. The tap chaser of claim 1, wherein the tap chaser is coated with at least one coating material.

11. The tap chaser of claim 10, wherein said coating material is at least one material selected from the group consisting of a metal carbide, a metal nitride, a metal silicide and a metal oxide of a metal selected from groups IIIA, IVB, VB, and VIB of the periodic table.

12. The tap chaser of claim 11, wherein said coating has a total thickness of 1 to 24 microns.

13. The tap chaser of claim 11, wherein said coating material is at least one material selected from the group consisting of titanium nitride, titanium carbonitride, titanium aluminum nitride, titanium aluminum nitride plus carbon, aluminum titanium nitride, aluminum titanium nitride plus carbon, titanium aluminum nitride plus tungsten carbide/carbon, aluminum titanium nitride plus tungsten carbide/carbon, aluminum oxide, titanium diboride, tungsten carbide carbon, chromium nitride, and aluminum chromium nitride.

14. A tap system adapted to tap an internal thread in a hole in a workpiece in a single pass, the tap system comprising a tap head and at least one removable tap chaser consisting of a carbide material, and wherein the tap chaser is removably attached to the tap head and, when worn or damaged, may be removed from the tap head and replaced or restored to useful condition and re-installed on the tap head.

15. The tap system of claim 14, wherein the tap system is selected from the group consisting of a collapsible tap system and a non-collapsible tap system.

16. A method for tapping an internal thread in a hole in a workpiece, the method comprising machining the workpiece with a tap system comprising a tap head and at least one removable tap chaser consisting of a carbide material, wherein the tap chaser is removably attached to the tap head and, when worn or damaged, may be removed from the tap head and replaced or restored to useful condition and re-installed on the tap head.
